(19) United States
(12) Patent Application Publication
(10) Pub. No.: US 2023/0366522 A1
(43) Pub. Date: Nov. 16, 2023

(54) LIGHT CONTROL IN AN OPTICAL ELEMENT

(71) Applicant: Valeo North America, Inc., Troy, MI (US)

(72) Inventors: Brian GUINN, Troy, MI (US); Colby DARLAGE, Troy, MI (US); Robert Leon FRAIZER, Troy, MI (US)

(73) Assignee: Valeo North America, Inc., Troy, MI (US)

(21) Appl. No.: 17/743,822

(22) Filed: May 13, 2022

(51) Int. Cl. F21S 41/40; F21S 41/27; F21S 41/143; F21S 41/151; F21S 41/145; F21S 41/32; B23K 26/53

(52) U.S. Cl. CPC F21S 41/40; B23K 26/53; F21S 41/143; F21S 41/145; F21S 41/151; F21S 41/27; F21S 41/321

(57) ABSTRACT

The present invention pertains to a lighting device for an automobile comprising a housing, a plurality of light sources arranged inside the housing and an optical element arranged in front of the plurality of light source. The optical element includes an input surface, an output surface and a transparent portion that is disposed between the input surface and the output surface. In addition, the optical element includes at least one part of the transparent portion having a blocking portion that is created using a laser treatment. The blocking portion is configured to block at least a part of the plurality of light beams from passing through the optical element.

### FIELD OF THE INVENTION

The present invention relates to a lighting device for an automobile. More particularly, the present invention relates to a lighting device for an automobile having an optical element arranged in front of the plurality of light source.

### BACKGROUND

Lighting devices are used in automobiles and the like, for lighting the path ahead. Currently, lighting devices are available with multiple lighting modules. The lighting modules are designed to produce distinct lights beam to provide different lighting functions such as high beam, low beam, turn indicator, day running lights etc. The indicated lighting functions use specific light sources and are required by regulations to meet certain lighting conditions. At the same time, the efficiency and functionality of the lighting devices needs to be meet the design requirement. In modem lighting devices designed such that plurality of modules are integrated in a single housing.

Regulations require that each of the lighting modules generate distinct light patterns. Further, the different light patterns are not supposed mix with each other, as this may reduce the efficiency and, in addition, may not be able to meet the regulatory requirements. In most of the lighting devices the lighting modules are separated by an internal wall or are arranged in individual chambers inside the lighting device housing. However, the lighting devices are provided with a single outer lens for aesthetic and design purposes. The arrangement makes it difficult to prevent the light mixing or light leakage between the distinct lighting modules.

The inventive concept herein overcomes the multiple problems and shortcomings of the conventionally affected lighting devices and generally known associated limitations that hinder effective lighting functionality and light beam pattern generation using the lighting devices.

The “background” description provided herein is for purposes of presenting the general context of the disclosure. Work of the presently named inventors, to the extent it is described in this background section, as well as aspects of the description, which may not otherwise qualify as conventional art at the time of filing, are neither expressly nor impliedly admitted as conventional art against the present disclosure.

### SUMMARY OF THE INVENTION

The present invention is directed to a unique solution that addresses at least one or more of the described issues in paragraphs above. It is believed that the lighting device of the present invention can effectively generate different lighting function meeting the regulatory and design requirements. Furthermore, the proposed lighting device prevents light leakage and mixing of light pattern generated by various lighting modules of the lighting device. In addition, the present invention’s lighting device is capable of provide clear and distinct light patterns. Moreover, the present lighting device allows use of a single optical element thus enabling compact design for the lighting device.

Accordingly, pursuant to a first aspect of the present invention, there is contemplated a lighting device for an automobile including a housing, a plurality of light sources arranged inside the housing for producing a plurality of light beams and an optical element arranged in front of the plurality of light source. The optical element includes an input surface, an output surface, and a transparent portion disposed between the input surface and the output surface. The transparent portion is configured to receive the plurality of light beams through the input surface and disperse the plurality of light beams through the output surface. Further, at least one part of the transparent portion includes a blocking portion created using a laser treatment that blocks at least a part of the plurality of light beams from passing through the optical element.

The invention may be further characterized by one or any combination of the features described herein, such as; wherein the laser treatment forms a laser damaged region in the transparent portion to form the blocking portion; wherein the laser damaged region is a physical degradation of the transparent portion by laser; wherein the housing includes plurality of lighting chambers separated from each other; wherein each of the plurality of light sources are arranged inside the respective lighting chambers and are configured to produce different light beams for different photometric functions; wherein the plurality of lighting chambers are separated by a wall portion that is configured to prevent light leakage between the lighting chambers; wherein the blocking portion is an internal light blocking portion; wherein the blocking portion splits the optical element into different photometric regions each associated with different photometric function; wherein the blocking portion is configured to prevent light leakage between the plurality of light sources; wherein the transparent portion includes at least one optics grid pattern created using laser treatment; wherein the optical element is an optical lens configured to disperse the light beam on to a surface.

Accordingly, pursuant to a second aspect of the present invention, contemplated is a method of providing an optical element for an automobile lighting device having a light blocking portion, the method includes providing an optical element that can be arranged in front of a plurality of light sources, with the optical element comprises an input surface, output surface and a transparent portion disposed between the input surface and the output surface. The method further includes creating a blocking portion in the transparent portion using a laser post process treatment.

The invention may be further characterized by one or any combination of the features described herein, such as; wherein creating the blocking portion includes passing a laser beam into the transparent portion to form a laser damaged region extending from the input surface to the output surface; wherein the laser damaged region comprises a plurality of defect area created by a physical degradation of the transparent portion; wherein the method further includes creating at least one optics grid pattern in the transparent portion using laser post process treatment.

It should be appreciated that the above referenced aspects and examples are non-limiting, as other aspects exist within the present invention, as shown and described herein.

### DESCRIPTION OF DRAWINGS

To further provide a more encompassing description and a better understanding of the invention, a set of drawings is provided. The drawings form an integral part of the description and illustrate embodiment aspects of the invention, which should not be construed as restricting the scope of the invention, but only as examples of how the invention can be carried out. The drawings comprise the following characteristics:

FIG. 1 shows a front view of a lighting device, according to an embodiment of the present invention.

FIG. 2a shows a cross sectional view of the lighting device of FIG. 1, according to an embodiment of the present invention.

FIG. 2b shows a cross sectional view of the lighting device of FIG. 1 depicting light blocking, according to an embodiment of the present invention.

FIG. 3 shows a cross sectional view of a lighting device, according to an embodiment of the present invention.

FIG. 4 shows the method for providing an optical element for an automobile lighting device with a light blocking portion, in accordance with an embodiment of the present invention.

### DETAILED DESCRIPTION OF PREFERRED EMBODIMENTS

Automotive lighting devices are provided in an automotive vehicle to light the path in front of the vehicle. Further, the lighting devices also perform other functions such as turn indicator (TI), Day running light (DRL), stop light function, tail light function, hazard light function etc. These lighting functions use different light sources that produce different color light beams as required for the lighting function. In lighting devices, all of the light sources may be designed to be housed inside a single lighting device housing. The light sources may be designed to be accommodated in separate light channels inside the light device housing. However, to avoid cost escalations and to maintain a compact design requirement the housing is mostly provided with a single optical element.

The present invention provides a lighting device that can effectively perform various lighting functions ensuring a compact light device. Furthermore, the proposed lighting device can effectively perform the lighting functions while preventing light leakage from one lighting function into another. In addition, the lighting device prevents light leakage without the introduction of additional components, thus allowing a cost effective compact design.

Unless defined otherwise, all technical and scientific terms used herein have the same meaning as commonly understood by one of ordinary skill in the art to which this technology belongs.

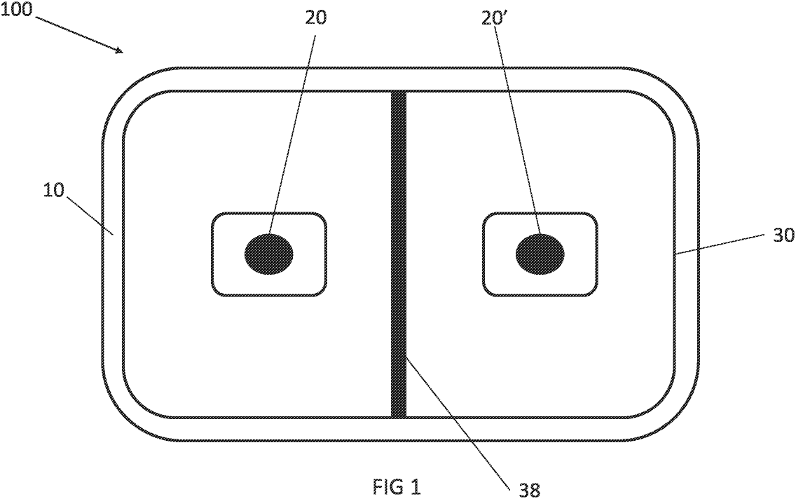

Of particular interest and a main focus of the present disclosure is to provide a lighting device 100 for an automotive vehicle as shown in FIG. 1. FIG. 1 shows the lighting device 100, according to an embodiment of the present invention.

A lighting device 100 can be defined as an device that is arranged on the exterior body of the automotive vehicle (sometimes can be arranged inside as well) and configured to produce a light beam using light sources 20. The lighting device 100 may be used for various lighting functions such low beam lighting, high beam lighting, Turn Indicator (TI), Day Running Light (DRL), tail light function, and/or stop light function. Different color light sources 20, 20′ can be used to produce the light beam for specific lighting functions as disclosed above.

The lighting device 100 can include a housing 10, The housing 10 can be defined as an enclosure that houses the components such as the light source 20, 20′, electronic components, wiring and wire harness’, heat exchangers (if any) and other components of the lighting device 100. The housing 10 protects the components from external exposure that may affect the functioning of the lighting device 100 and as well, as provides mounting and assembly provisions for the components. The hosing 10 can be designed such that it encloses the components of the lighting device 100 from all side leaving only a front side as open. The light sources 20, 20′ can be arranged inside the housing 10. The light beam produced by the light sources 20, 20′ can be configured to pass through the opening and can be visible to a viewer.

The lighting device 100 can include an optical element 30. The optical element 30 may be defined as a clear or transparent part that is arranged in front of the light sources 20, 20′. The optical element 30 can be affixed into or onto the housing 10. The optical element 30 can be arranged on the open end of the housing 10 facing the light sources 20, 20′. The optical element 30 can be designed to diverge, collimate, disperse, direct, or a combination of the preceding the light beam produced by the light sources 20, 20′. The optical element 30 can be configured to disperse the light beam to produce a lighting pattern pertaining to different lighting functions. The optical element 30 can include an optical lens and can be made of polycarbonate, plastic, glass, crystal and other similar material that allow the light beam to pass through.

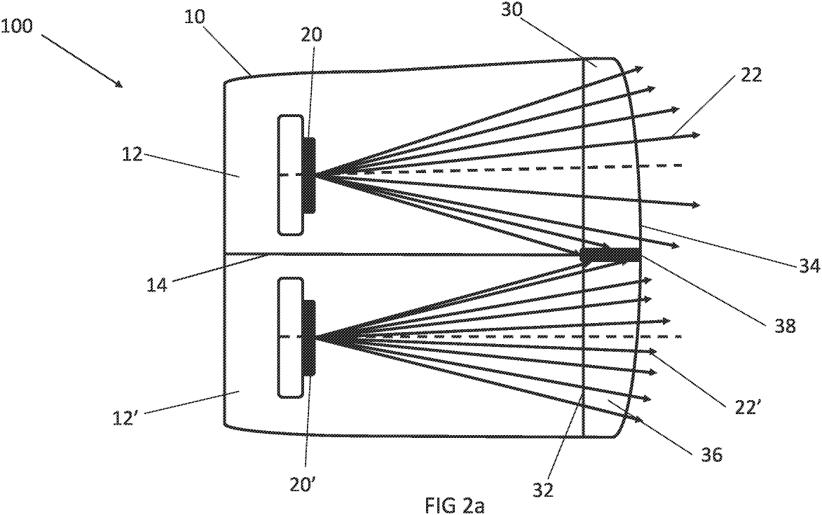

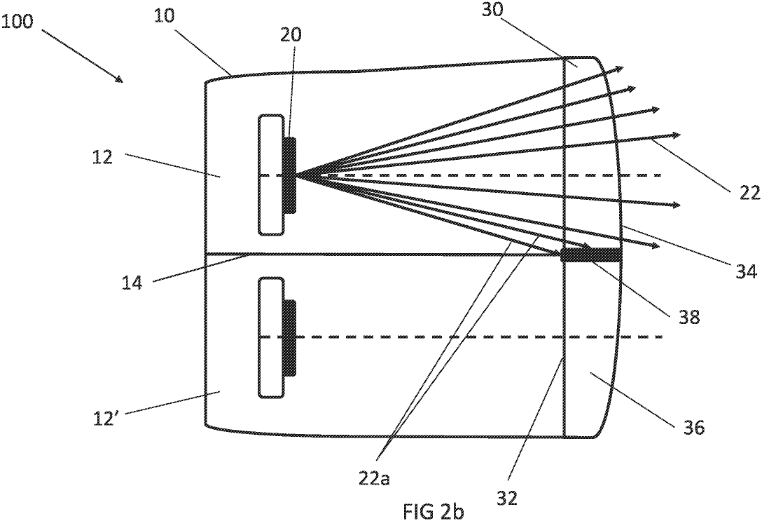

In an embodiment as shown in FIG. 2a, the lighting device 100 can include a plurality of lighting chambers 12, 12′. Each of the lighting chambers 12, 12′ can include a light source 20, 20′ that may be configured to produce different light beams 22, 22′ that may be distinct from each other. In an embodiment, the light sources 12, 12′ can be a white and an amber color, and, can be configured to produce DRL and TI functions respectively. The light chambers 12, 12′ can be designed to perform a single lighting function; however, the light chamber may perform multiple different functions as well. The lighting chambers 12, 12′ can be designed such that light beam from one chamber does not pass into the other chamber. A wall portion 14 that is configured to prevent light leakage between the lighting chambers 12, 12′ can separate the plurality of lighting chambers 12, 12′. This arrangement prevents light mixing between the light sources 20, 20′ arranged in each light chamber 12, 12′.

Further, as seen in FIG. 2a, the optical element 30 can be arranged facing light sources 20, 20′ of each of the light chambers 12, 12′. In a preferred embodiment of the present invention, the lighting device 100 comprises a single optical element 30, further, each of the lighting chambers 12, 12′ are arranged with respect to the optical element 30. As shown in the FIG. 2a, the optical element 30 includes an input surface 32, an output surface 34 and a transparent portion 36 that is disposed between the input surface 32 and the output surface 34. The input surface 32 can be arranged facing the light sources 20, 20′ and the output surface 34 can be arranged opposite to the input surface 32. Further, the transparent portion 36 can be configured to receive the plurality of light beams 22, 22′ through the input surface 32. In addition, the optical element 30 can be configured to disperse the plurality of light beams 22, 22′ through the output surface 34.

In an embodiment of the present invention, the lighting sources 20 and 20′ produce a first light beam 22 and second light beam 22′. The light sources 20, 20′ can be arranged respectively in the light chamber 12, 12′, further, as discussed above a single optical element 30 can be arranged facing the light sources 20, 20′. In an embodiment as shown in FIG. 1 and FIG. 2a, the transparent portion 36 includes a blocking portion 38 configured to prevent the first light beam 22 from mixing with the second light beam 22′ by blocking at least a part of the plurality of light beams 22, 22′ from passing through the optical element 30. Further, the blocking portion 38 can be configured to split the optical element 30 into different photometric regions each associated with different photometric function. In a preferred embodiment of the present invention, the blocking portion 38 is an internal light blocking portion that is formed in the transparent portion 38 of the optical element 30.

In a preferred embodiment, the blocking portion 38 can be created in the transparent portion 36 by using a laser treatment. The laser treatment forms a laser damaged region in the transparent portion 36 to form the blocking portion 38. The blocking portion 38 can be created extending from the input surface 32 to the output surface 34 or alternatively the blocking portion 38 may be created as a floating portion inside the transparent portion 36. The laser treatment essentially creates a physical degradation in the transparent portion 36 in the laser damaged region. The physical degradation can create a dark region as compared to rest of the transparent portion 36. The above indicated physical degradation prevents a portion of light beam 12 referred to as blocked beam 22a (see FIG. 2b) from passing through the optical element 30 and mix with the second light beam 12′ and vice versa.

The laser treatment method of the present invention may be designed to leave marks on an area of an object, which may include color change due to chemical/molecular alteration, charring, foaming, melting, ablation, and more. The method does not involve the use of inks, nor does it involve tool bits which contact the engraving surface and wear out, giving it an advantage over alternative engraving or marking. Specific tools may be used to perform the laser treatment of the present invention. A controller allowing tracing a pattern onto the area may control the laser beam emitted from such tools. The controller may determine the direction, intensity, speed of movement, and spread of the laser beam aimed at the area on the surface or in some cases in a subsurface area. The laser beam is controlled such that the point where the laser beam touches the material is typically placed on the focal plane of the laser’s optical system and is usually synonymous with its focal point. This point is typically small, in addition, only the area inside said focal point is affected giving precise control. The energy delivered by the laser changes the surface of the material at the focal point. It may heat up the surface and subsequently vaporize the material, or perhaps the material may fracture known as glassing or glassing up and flake off the surface.

More specifically, the Laser treatment of the present invention involves sub-surface laser engraving. The process involves engraving an image in a transparent solid material by focusing a laser below the surface to create small fractures. Such engraved materials are of high-grade optical quality (suitable for lenses, with low dispersion) to minimize distortion of the beam. As disclosed previously, the Laser beam is focused on a predetermined area in the sub-surface such as transparent portion 36 of the optical element 30. The Laser beam creates color change due to chemical/molecular alteration or may create charring at said area. Due to the above process, a blocking portion 38 may be created that is of a darker shade or color as compared to the rest of the transparent portion 36. The blocking area 38 being darker prevents the light beam from passing through and thus preventing light leakage.

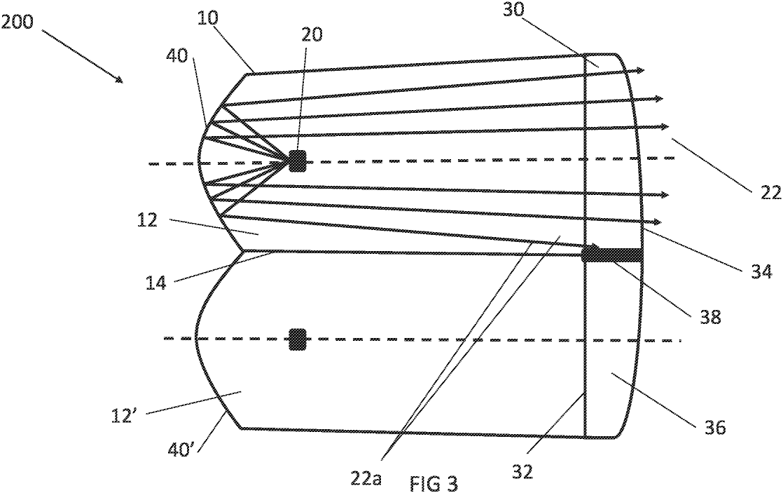

FIG. 3 shows a cross sectional view of a lighting device 200 as an embodiment of the present invention. The lighting device 200 includes the light sources 20, 20′ that can be arranged facing away from the optical element 30. Reflectors 40, 40′ can be arranged in the light chambers 12, 12′ to reflect the light beams 22, 22′ towards the optical element 30. The optical element 30 includes the input surface 32, the output surface 34 and the transparent portion 36. The transparent portion 36 further includes a laser treated blocking portion 38 that can be configured to block a portion of the light beams 22, 22′ from passing through the optical element 30. Alternatively, the transparent portion 36 can include at least one optics grid pattern that can be created using laser treatment. The optics grid pattern can be used to produce an image or to produce a specific light beam distribution.

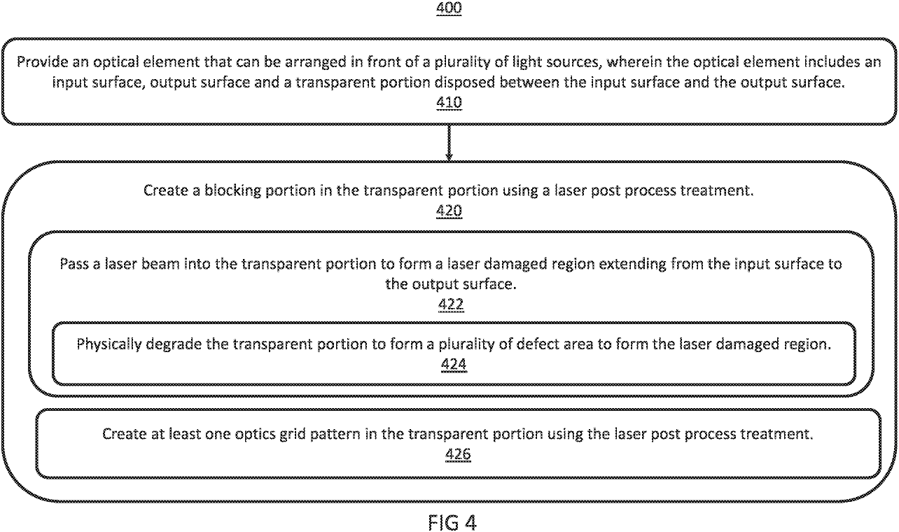

FIG. 4 illustratively shows and describes methods 400 for providing an optical element for an automobile lighting device with a light blocking portion. In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions

In block 410, an optical element is provided and arranged in front of a plurality of light sources, with the optical element including an input surface, output surface and a transparent portion disposed between the input surface and the output surface. In block 420, a blocking portion is created in the transparent portion using laser post process treatment. In block 422, a laser beam is passed into the transparent portion to form a laser damaged region extending from the input surface to the output surface. In block 424, physically degrade the transparent portion to form a plurality of defect area to form the laser damaged region. In block 426, at least one optics grid pattern is created in the transparent portion 36 using the laser post process treatment.

Although the present disclosure provides references to figures, all embodiments shown in the figures are intended to explain preferred embodiments of the present invention by way of example rather than being intended to limit the present invention. Preferred embodiments of the present invention have been disclosed. However, it should be apparent to a person of ordinary skill in the art that certain modifications would come within the teachings of this invention and that various changes or modifications may be made in the present disclosure without departing from the principles and spirit of the disclosure, which are intended to be covered by the present invention as long as these changes or modifications fall within the scope defined in the claims and their equivalents.

### LIST OF ELEMENT NUMBERS

lighting device 100, 200
housing 10
lighting chamber 12, 12′
wall 14
light sources 20, 20′
light beam 22, 22′
blocked beam 22a
optical element 30
input surface 32
output surface 34
transparent portion 36
blocking portion 38
reflector 40, 40′

What is climed is:

1. A lighting device for an automobile comprising:
a housing with two lighting chambers, with the housing having an integrated wall that separates the two lighting chambers;
a plurality of light sources arranged inside the two lighting chambers for producing a plurality of light beams;
an optical element arranged in front of the plurality of light sources and over the wall, with the optical element including an input surface, an output surface and a transparent portion disposed between the input surface and the output surface, with the transparent portion being configured to receive the plurality of light beams through the input surface and disperse the plurality of light beams through the output surface; and
at least one part of the transparent portion above and adjacent to the wall includes a blocking portion created using a laser treatment that is configured to block at least a part of the plurality of light beams from passing through the optical element.

2. The lighting device as claimed in claim 1, wherein the laser treatment forms a laser damaged region in the transparent portion to form the blocking portion.

3. The lighting device as claimed in claim 2, wherein the laser damaged region is a physical degradation of the transparent portion by laser.

4. (canceled)

5. The lighting device as claimed in claim 1, wherein the plurality of light sources arranged inside each of the two lighting chambers are configured to produce different light beams for different photometric functions.

6. The lighting device as claimed in claim 1, wherein the wall portion is configured to prevent light leakage between the two lighting chambers.

7. The lighting device as claimed in claim 1, wherein the blocking portion is an internal light blocking portion.

8. The lighting device as claimed in claim 1, wherein the blocking portion splits the optical element into different photometric regions each associated with different photometric function.

9. The lighting device as claimed in claim 1, wherein the blocking portion is configured to prevent light leakage between the two lighting chambers.

10. The lighting device as claimed in claim 1, wherein the transparent portion includes at least one optics grid pattern created using the laser treatment.

11. The lighting device as claimed in claim 1, wherein the optical element is an optical lens configured to disperse the light beam onto a surface.

12-15. (canceled)

16. The lighting device as claimed in claim 1, wherein the housing includes only two light chambers.
